(19) United States
(12) Patent Application Publication
(10) Pub. No.: US 2023/0413868 A1
(43) Pub. Date: Dec. 28, 2023

(54) FOOD ADDITIVES AND METHODS FOR PREPARING THE SAME

(71) Applicant: BASF SE, Ludwigshafen am Rhein (DE)

(72) Inventors: John L. Foley, Tarrytown, NY (US); Christian Koepsel, Ludwigshafen am Rhein (DE)

(21) Appl. No.: 17/767,697

(22) PCT Filed: Nov. 12, 2020
(86) PCT No.: PCT/US2020/060099

§ 371 Date: Apr. 8, 2022

Related U.S. Application Data
(60) Provisional application No. 62/935,909, filed on Nov. 15, 2019.

(51) Int. Cl. A23L 5/20; A23L 5/44; A23D 7/005; A23D 7/04; A23L 2/58

(52) U.S. Cl. CPC A23L 5/21; A23L 5/44; A23L 2/58; A23D 7/04; A23D 7/0053

(57) ABSTRACT

This disclosure relates to a method for improving a sensory characteristic of a carotenoid composition including providing a carotenoid composition into a reaction vessel and holding the carotenoid composition at a holding temperature between 50° C. to 180° C. while purging atmosphere from the reaction vessel for a suitable time to remove volatile odor-causing impurities from the carotenoid composition. This disclosure also relates to carotenoid food additive formulations prepared according to the above method.

### FIELD OF INVENTION

This disclosure relates to methods for preparing food additive compositions and foods and beverages containing the same. In particular, this disclosure relates to beta-carotene and other carotenoid products with improved sensory qualities suitable for use in foods and beverages.

### BACKGROUND

Synthetic azo dyes yellow 5 and yellow 6 are commonly used food colorants. However, due to consumer preferences, the commercial food industry is trending away from synthetic color and flavor additives and toward food products that are considered “natural.” Accordingly, plant-derived compounds are increasingly being used as color and flavor additives.

Carotenoids are a class of more than 600 hydrocarbons (carotenes) that are suitable for such purposes. For example, U.S. Pat. No. 9,375,387, which is incorporated by reference in its entirety, describes a carotenoid composition suitable for use in animal and human foods, dietary supplements, cosmetic compositions and pharmaceuticals.

Carotenoids are the pigments responsible for the colors of many plants, fruits and flowers. Carotenoids are typically C30-C40 compounds having double bonds and other chemical groups that can make them reactive and susceptible to decomposition into smaller molecular weight compounds that give rise to various aromas. For example, C9 to C13 compounds like as beta-Ionone (C13) and the like, are compounds associated with floral and vegetal odors (see, Carotenoids as Flavor & Fragrance Precursors: A Review, by John C. Leffingwell. Ph.D.). Carotenoids are also important in human nutrition as a source of Vitamin A and are believed to help prevent cancer and heart disease. Accordingly, it is desirable to develop natural food additives from carotenoids to obtain pleasing sensory attributes, including color and minimal odor.

### SUMMARY

Aspects of this disclosure relate to a method for improving the sensory characteristics of a carotenoid food additive formulation comprising providing a carotenoid composition into a reaction vessel and holding the carotenoid composition at a holding temperature between 50° C. to 180° C. while purging atmosphere from the reaction vessel for a suitable time to remove volatile odor-causing impurities from the carotenoid composition.

Aspects of this disclosure also relate to carotenoid food additive formulations having improved sensory properties.

### DESCRIPTION

Beta-carotene and other carotenoids are used as food additives, especially for fortifying, flavoring and coloring foods and beverages. Commercial beta-carotene and carotenoid products containing alpha-carotene, lycopene, lutein, and beta-apocarotenal exhibit distinct odors. In addition to having a distinctive odor, existing commercial products may cause foods and beverages to appear orange in color. While the odor and color of commercial carotenoid food additive are acceptable or even desirable for many current applications, there are some applications in which lower odor and/or a more yellow color is desired.

This disclosure provides methods for producing carotenoid food additive formulations that exhibit improved sensory properties compared to existing carotenoid products. The improved sensory properties allow the carotenoids to be used in a wider variety of food, beverage and dietary supplement products in which the odor and/or orange color may be undesirable.

While not wishing to be bound by theory, it is believed that at least a portion of “off-odors” in commercially available carotenoid food additives is due to the presence of impurities, especially small molecular weight volatile degradation compounds, that may be by-products of the synthesis process or degradation of carotenoid compounds. Accordingly, while many carotenoid compounds are associated with their own odors, the presence of degradation products in a carotenoid composition may cause excessive or undesired odor or color. Where such compounds are present in commercially synthesized or naturally derived carotenoids food additives, treatment sufficient to remove volatile degradation compounds and other impurities is believed to reduce the total amount of odor-causing components in the carotenoid food additive and result in improved sensory properties. Based on this theory, this disclosure relates to processes for preparing food additive formulations using carotenoid compositions that reduce the amount of volatile degradation compounds and other impurities to provide improved sensory properties in terms of lower odor and color that is more yellow than orange.

Suitable carotenoid compositions for starting materials include those comprising at least one of β-carotene, lycopene, bixin, zeaxanthin, cryptoxanthin, citranaxanthin, lutein, canthaxanthin, astaxanthin, β-apo-4′-carotenal, β-apo-8′-carotenal, β-apo-12′-carotenal, β-apo-8′-carotenic acid and esters of hydroxy- and carboxy-containing representatives of this group, e.g. the lower alkyl esters and preferably the methyl esters and ethyl esters. Particularly preferably, readily industrially obtainable representatives are used, such as β-carotene, canthaxanthin, astaxanthin, lycopene, β-apo-8′-carotenal and β-apo-8′-carotenic esters, alone or as a mixture. The carotenoids may be naturally-derived or a commercially synthesized “nature identical,” meaning that the active ingredient is chemically identical to a naturally occurring carotenoid. Beta-carotene is preferred. Suitable beta-carotene is commercially available as LUCAROTIN® (trademark of BASF SE).

As noted above, it is believed that commercial carotenoid compositions contain one or more off-odor causing impurities, such as minor amounts of volatile small molecules and degradation products and the like. Accordingly, reference herein to a “carotenoid composition” encompasses compositions comprising a minor fraction of impurities and should not be interpreted as referring to a naturally-occurring molecule per se of the desired carotenoid or a pure composition exclusively consisting of the desired carotenoid molecules.

The carotenoid composition may be in the form of a powder, solution, suspension, emulsion, dispersion and beadlet or other commercially available forms. The carotenoid composition may contain one or more solvents, diluents, excipients, carriers, dispersing agents, and the like used to prepare commercially available carotenoid compositions without departing from this disclosure. Examples include starches, plant derived gums, gelatins, oils, sugars, resins, fats, waxes, softeners and inorganic fillers and the like.

In some examples, the carotenoid composition may be in the form of an oily dispersion in any edible oil suitable for animal and/or human nutrition. The edible oil may be a synthetic oil, mineral oil, vegetable oil or animal-derived oil. Examples of suitable vegetable oils include but are not limited to soybean oil, palm oil, palm kernel oil, sunflower oil, corn oil, linseed oil, cottonseed oil, tocopherols, rapeseed oil, safflower oil, wheat germ oil, rice bran oil, coconut oil, almond oil, apricot kernel oil, avocado oil, jojoba oil, hazelnut oil, walnut oil, peanut oil, pistachio oil, and vegetable sources of medium chain fatty acid triglyceride (MCT oil). Suitable synthetic oils include by are not limited to semi-synthetic triglycerides, such as caprylic/capric triglycerides such as Miglyol type, as well as tallow stearin, liquid paraffin, glyceryl stearate, isopropyl myristate, adipate, diisopropyl ester, 2-ethylhexanoate, stearyl acetyl esters, liquid hydrogenated polyisobutene, squalane, squalene. Suitable animal oils include oils and fats such as lard oil, tallow oil, fish oil, including mackerel oil, sprat oil, tuna oil, halibut oil, cod oil and salmon oil, commercially available mixtures of fish oil and fish oils such as South America, North Europe and fish menhaden oil, and lanolin. Mixtures of one more oils are also suitable. Particularly preferable are vegetable oils such as soybean oil, palm oil, palm kernel oil, sunflower oil, safflower oil, corn oil, olive oil, linseed oil, rapeseed oil, rice bran oil, coconut oil, peanut oil, MCT oil, and mixtures thereof.

In examples of an oil solution and/or suspension, the total amount of oil is not limited and may comprise up to 99% by weight of the oil solution and/or suspension, or preferably up to 60% by weight, or more preferably up to 50% by weight.

To protect the carotenoids in the carotenoid composition against oxidative decomposition, stabilizers and antioxidants can additionally be included. Examples of customary antioxidants include but are not limited to vitamin E, vitamin C, butylated hydroxytoluene, butylated hydroxyanisole, ascorbyl palmitate, ascorbic acid, sodium ascorbate and d, 1-α-tocopherol and d,1-α-tocopherol esters.

Methods for preparing suitable carotenoid food additives with improved sensory properties are discussed below. The methods are aimed at removing or reducing the amount of volatile impurities and degradation products.

A preferred process for improving the sensory properties of the carotenoid composition comprises subjecting a carotenoid composition, along with any dispersing agent, additives, etc., to holding while purging and/or sparging with an inert gas to remove volatilized volatile compounds from the carotenoid composition. The process may be performed in any suitable reaction vessel.

The holding step includes holding the carotenoid composition for a time suitable to remove a sufficient amount of volatilized volatile odor-causing impurities to improve the sensory properties of the carotenoid composition relative to the untreated carotenoid composition. Preferably, the holding step occurs at a holding temperature between 50° C. and 180° C., more preferably between 70° C. and 110° C., even more preferably between 80° C. and 100° C., or any temperature therebetween.

The length of the holding time suitable to remove a sufficient amount of volatilized volatile odor-causing impurities depends on the holding temperature as temperature may affect the rate of volatilization of small molecules. A higher temperature can require a lower holding time, whereas a lower temperature may require a longer holding time. In some examples, the holding time may be at least 30 minutes or more, preferably at least 2 hours or more, or even more preferably at least 3 hours or more. The upper limit of the holding time is not generally not limited and may be set to 4 hours or up to 12 hours hour or more.

The holding step is at least partially performed in conjunction with atmosphere purging to remove volatile odor-causing impurities from the reaction vessel. Preferably, the holding step is performed while continuously purging the atmosphere from the reaction vessel.

The atmosphere of the reaction vessel can be purged by any process suitable to remove volatilized volatile compounds from the reaction vessel, including, but not limited to introducing an inert gas into the reaction vessel while exhausting the atmosphere from the reaction vessel. Non-limiting examples of an inert gas include nitrogen, carbon dioxide and steam or a combination thereof. Preferably, purging includes nitrogen sparging for introducing nitrogen into the carotenoid composition in the reaction vessel. Additionally, or alternatively, the reaction vessel may be subjected to vacuum or reduced pressure (below 1 atm) to remove volatilized volatile compounds from the carotenoid composition.

Optionally, the process may further include a heat treatment step performed before or after holding. In the heat treatment step, the carotenoid composition is preferably heated to a minimum temperature high enough to dissolve or melt the carotenoid composition. Preferably, the upper limit of the heat treatment temperature is below the temperature at which the carotenoid degrades. Suitable heat treatment temperatures may be between 130° C. and 250° C., more preferably between 150° C. and 225° C., even more preferably between 170° C. and 180° C., or any temperature therebetween. The duration of the heat treatment is not limited, but suitably may be 40 minutes or less, more preferably 30 minutes or less, more preferably 20 minutes or less, or more preferably 10 minutes or less.

Preferably, the heat treatment is also at least partially performed in conjunction with purging the atmosphere from the reaction vessel. Even more preferably, the heat treatment step is performed while continuously purging the atmosphere from the reaction vessel.

Suitable processes for improving the sensory properties of a carotenoid composition may further include performing a crystallization step to sufficiently reduce the amount of volatile degradation products present in the crystalline product. Additionally, processing a carotenoid composition may include a period of elevated temperature with or without reduced pressure, with or without a stripping agent such as nitrogen, steam or solvent, to reduce the content of volatile degradation products. Additionally, or alternatively, evaporation techniques such as wiped film evaporation, falling film evaporation with or without the addition of a stripping agent such as nitrogen, steam or solvent may be utilized to remove sufficient amounts of volatile degradation products to improve the sensory properties of the carotenoid composition. Additionally, or alternatively, the carotenoid composition may be subjected to distillation to remove sufficient amounts of volatile degradation products.

Removal of a “sufficient amount” of volatilized volatile odor-causing impurities to improve the sensory properties of the carotenoid composition can be assessed by evaluating the odor and color of the treated carotenoid composition.

Assessment of the removal of a sufficient amount of volatilized volatile odor-causing impurities to improve the sensory properties of the carotenoid composition can be performed using sensory panels according to methods known in the art. A suitable sensory evaluation is the Difference Test described in Sensory Evaluation Techniques 2nd edition Meilgaard, Civile, Can 1991 Pages 81-88, which is incorporated herein by reference. In the Difference Test, a sensory panel compares the odor of a carotenoid composition having between 1 and 6 ppm of the carotenoid with an odorless control, namely, Yellow 5, to evaluate the intensity of odor of the carotenoid composition. Panelists also evaluate the Control against itself to assess the accuracy of results.

The intensity of the odor is ranked on a scale of 0 to 10, with 0 being no difference compared to control and 10 being an extreme difference. The ranking values assigned by ten people (N=10) are gathered and averaged to arrive at an odor intensity value.

Removal of a “sufficient amount” of volatilized volatile odor-causing impurities to improve the sensory properties of the carotenoid composition generally corresponds to an odor intensity value of not greater than 5, preferably not greater than 4.

Additionally, or alternatively, assessment of the removal of a sufficient amount of volatilized impurities to improve the sensory properties of the carotenoid composition can also be performed using Gas chromatography (GC) headspace analysis.

Preferably, the color of the carotenoid composition after treatment may be similar to Yellow No. 5 (i.e., tartrazine), which is a yellow pigment. Thus, after treatment, the carotenoid composition may absorb light in the visible region similar to that of Yellow #5.

The carotenoid food additive formulations may be formulated as oil suspensions or solutions, powders, emulsions, dispersions, beadlets and the like by techniques known in the art. The form of the carotenoid food additive may influence the suitable amount of carotenoid in the composition. For example, a suitable oil solution may contain one or more carotenoids in an amount of up to 30% by weight, up to 20% by weight, or up to 15% by weight. The amount of the one or more carotenoids depends on the desired applications and can be selected by those skilled in the art.

### EXAMPLES

### Example 1: Preparation of an 12% Beta-Carotene Oil Suspension

Commercially available beta-carotene (LUCAROTIN®) was mixed with medium chain triglycerides and alpha-tocopherol as an antioxidant in the amounts shown in Table 1 to obtain a 12% beta-carotene composition and charged into a 500 mL reactor.

TABLE 1

| | | | | | | Experi- | % |
|---|---|---|---|---|---|---|---|
| Item | | lot | % | Target | Weight | mental | Active |
| # | Material | # | Weight | g | active | weight | final |
| 1 | MCT | | 53.80% | 96.84 | 96.84 | 102.20 | |
| 2 | Lucarotin | | 40.00% | 72.00 | 22.320 | 76.160 | 12.40% |
| | 30% | | | | | | |
| 3 | alpha- | | 6.20% | 11.16 | 10.83 | 12.30 | 6.01% |
| | Tocopherol | | | | | | |
| | Total 1-3 | | 100.00% | 180.00 | | | |
| | Total 1-3 | | | | | 190.66 | |
| | (actual) | | | | | | |
| | Target Batch | | | 180.00 | | | |
| | size g | | | | | | |

The reactor was purged with nitrogen sparging and purging was maintained under exhaust fan while the mixture was subjected to heat treatment and holding under the conditions set forth in Table 2.

TABLE 2

| Time (hour:min.) | Temp (° C.) |
|---|---|
| 0:00 | 25 |
| 0:05 | (NR) |
| 0:10 | 89 |
| 0:15 | 136 |
| 0:18 | 142 |
| 0:21 | 158 |
| 0:24 | 156 |
| 0:25 | 159 |
| 0:26 | 162 |
| 0:27 | 163 |
| 0:28 | 164 |
| 0:30 | 164 |
| 0:32 | 162 |
| 0:34 | 158 |
| 0:39 | 148 |
| 1:04 | 101 |
| 1:30 | 73 |
| 2:00 | 94 |
| 2:16 | 82 |
| 2:37 | 94 |
| 2:40 | 97 |
| 2:50 | 90 |
| 3:11 | 72 |
| 3:22 | 66 |
| 3:55 | 87 |
| 4:13 | 87 |

Thereafter, the contents of the reactor were allowed to cool and were decanted when the temperature fell below 50° C.

### Example 2: Preparation of an Emulsion

The 12% beta-carotene oil suspension prepared in Example 1 (12% BC oil) was used to make a 0.975% beta-carotene emulsion using the materials and amount of components set forth in Table 3.

TABLE 3

| Emulsion | Amount (g) |
|---|---|
| OSI starch (Capsul) | 152.2 |
| Ascorbic Acid | 0.43 |
| Citric acid | 1.42 |
| 12% BC oil | 31.5 |
| K-sorbate | 0.45 |
| Water | 216.5 |
| Total | 400.63 |

The sorbate starch was mixed in water at 50° C. for 5 minutes, then ascorbic acid and citric acid were added and mixed mix for 60 minutes total until a clear solution formed. The 12% BC oil (about 50° C.) was poured on top of starch solution and the mixture was mixed with a rotascrew mixer for 2 minutes under heat to 60° C. The mixture was then subjected to high pressure homogenization in at 50bar. The resulting emulsion was stored at room temperature.

Observation of the emulsion indicated a very small amount of black fine floaters, possibly (crystalline beta-carotene) on top of the emulsion prior to high pressure homogenization and residue on walls at the bottom of reaction flask.

### Example 3: Preparation of Beverage

0.31 g of the emulsion from Example 2 was placed into a 500 ml bottle with 50 ml stabilizer and a balance of water to obtain about 3 mg of beta-carotene in the bottle. The resulting beverage was slightly cloudy had a yellow color similar to that of yellow 5 and no detectable odor.

### Comparative Example 1: Preparation of a Beverage with Commercial Carotenoid Composition

0.3 g of the commercially available carotenoid composition LUCAROTIN® 1 CWD/Y (CAS: 7235-40-7 commercially available from BASF SE) was placed into a 500 ml bottle with a balance of water to obtain about 2.9 mg of beta-carotene in the bottle. The resulting beverage was more orange in color than the beverage of Example 3 and had a detectable carrot-like odor.

### Example 4: Preparation of a Beta-Carotene Oil Suspension

Commercially available beta-carotene was suspended in oil and charged into a reactor and subjected to holding at a temperature between 60 and 120° C. for 2 to 8 hours to remove small volatile molecule. Thereafter, the oil was heat treated at a temperature between 160 and 180° C. The resulting oil was made into an emulsion, then spray dried to obtain a powder.

### Example 5: Preparation of a Beta-Carotene Powder

A commercial beta-carotene powder was subjected to holding at a temperature between 60 and 120° C. for between 2 and 24 hours under vacuum. The resulting powder had improved sensory properties compared to the untreated powder.

### Example 6: Prophetic Analysis of Odor Intensity for Beta-Carotene Compositions

Using the Difference Test as described in Sensory Evaluation Techniques 2nd edition Meilgaard, Civile, Can 1991 Pages 81-88, samples at 1-6 ppm of beta-carotene were compared to Control (Yellow 5 at 20-40 ppm). Sample A corresponds to a beta-carotene composition prepared according to Example 1, whereas Samples B, C, D, and E are untreated commercially available beta-carotenes from various manufacturers. Each Sample and Control also contained 0.1% citric acid, 0.02% Ascorbic acid and 8% sucrose.

Panelists were presented with the Control (labeled as C) and one of the samples under a random 3 digit number and asked to rank the difference from control on a scale of 0 10; with 0 being no difference and 10 being extreme difference (N=10). The testing was repeated until each panelist analyzed each sample to the control. The results are shown in Table 4.

TABLE 4

| | Con- | Sample | Sample | Sample | Sample | Sample |
|---|---|---|---|---|---|---|
| Attribute | trol | A | B | C | D | E |
| Average | 1.5 | 3.5 | 5.2 | 6.5 | 6.0 | 6.3 |
| score | | | | | | |

We claim:

1. A method for improving a sensory characteristic of a carotenoid composition having volatile impurities comprising:
providing the carotenoid composition into a reaction vessel; and
holding the carotenoid composition at a holding temperature between 50° C. and 180° C. while purging atmosphere from the reaction vessel for a time suitable to remove a sufficient amount of volatilized volatile odor-causing impurities.

2. The method according to claim 1, wherein the purging comprises introducing an inert gas into the reaction vessel, subjecting the reaction vessel to vacuum or a combination thereof.

3. The method according to claim 1, wherein the purging comprises nitrogen sparging.

4. The method according to claim 1, wherein the purging is continuous during the holding.

5. The method according to claim 1, further comprising a heat treatment of subjecting the carotenoid composition to a temperature between 130° C. and 250° C.

6. The method according to claim 5, wherein the heat treatment is before the holding step.

7. The method according to claim 5, wherein the heat treatment is after the holding step.

8. The method according to claim 5, wherein the heat treatment comprises purging atmosphere from the reaction vessel.

9. The method according to claim 1, wherein the holding comprises holding the carotenoid composition at the holding temperature for at least 30 minutes.

10. The method according to claim 1, wherein the holding comprises holding the carotenoid composition at the holding temperature between 1 and 4 hours.

11. The method according to claim 1, wherein the carotenoid composition comprises at least one edible oil.

12. The method according to claim 1, wherein the carotenoid composition comprises at least one antioxidant.

13. The method according to claim 1, wherein the carotenoid composition comprises at least one carotenoid selected from the group consisting of n-carotene, canthaxanthin, astaxanthin, lycopine, β-apo-8′-carotenal and β-apo-8′-carotenic esters, alone or as a mixture.

14. The method according to claim 1, further comprising formulating the carotenoid composition in the form of an emulsion, powder, oily dispersion, or beadlet after the holding.

15. A carotenoid food additive formulation prepared according to the method of claim 1.

16. A carotenoid food additive formulation comprising a carotenoid composition having an odor intensity value of not more than 5.

17. The carotenoid food additive formulation according to claim 16, having an odor intensity value of not more than 4.

18. The carotenoid food additive formulation according to claim 16, wherein the carotenoid composition comprises at least one synthetic carotenoid.
